(19) United States
(12) Patent Application Publication
(10) Pub. No.: US 2016/0127651 A1
(43) Pub. Date: May 5, 2016

(54) ELECTRONIC DEVICE AND METHOD FOR CAPTURING IMAGE USING ASSISTANT ICON

(71) Applicant: Chiun Mai Communication Systems, Inc., New Taipei (TW)

(72) Inventor: PEI-FANG LIU, New Taipei (TW)

(21) Appl. No.: 14/584,638

(22) Filed: Dec. 29, 2014

(30) Foreign Application Priority Data
Nov. 4, 2014 (CN) 201410614724.5

(51) Int. Cl. H04N 5/232; G06F 3/0484; G06T 7/00; G06F 3/0481; G06F 3/0489

(52) U.S. Cl. CPC H04N 5/23293; G06F 3/04817; G06F 3/0489; H04N 5/23222; G06T 7/004; G06F 3/04845

(57) ABSTRACT

An electronic device obtains a preview of a video captured by the electronic device. The electronic device generates an assistant icon in the preview of the video. The electronic device captures an image of a scene when a desired object enters into the preview of the video and moves to a predetermined position.

### CROSS-REFERENCE TO RELATED APPLICATIONS

This application claims priority to Chinese Patent Application No. 201410614724.5 filed on Nov. 4, 2014, the contents of which are incorporated by reference herein.

### FIELD

The subject matter herein generally relates to image capturing technology, and particularly to an electronic device and a method for capturing an image using an assistant icon.

### BACKGROUND

Tourists often capture images of scenes while traveling. However, a tourist may be dissatisfied with a captured image. For example, one or more elements may be missing from the captured image of the scene.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of an electronic device.

FIG. 2 shows a diagrammatic view of an example of a preview of a video.

FIG. 3 shows a diagrammatic view of an example of an assistant icon in the preview of the video.

FIG. 4 shows a diagrammatic view of an example of capturing the image using the assistant icon.

FIG. 5 is a flowchart of an example embodiment of a method for capturing an image using the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

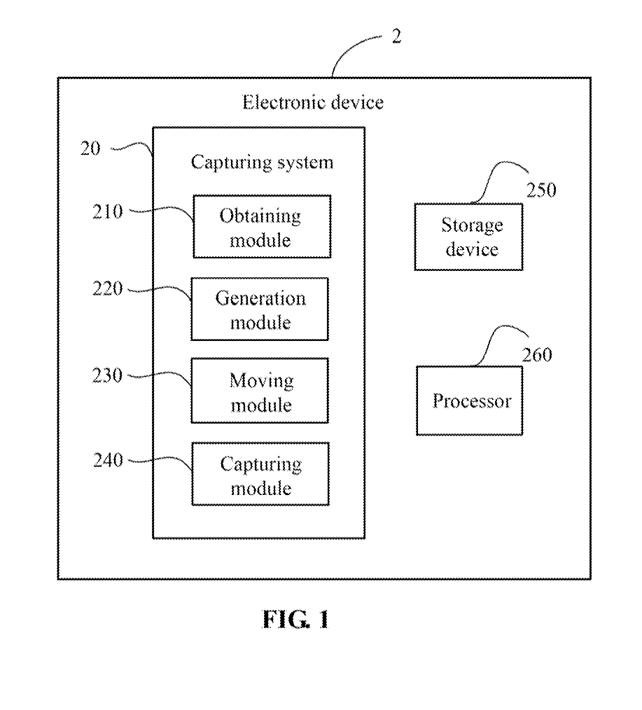

FIG. 1 is a block diagram of an example embodiment of an electronic device 2. In the example embodiment, the electronic device 2 includes, but is not limited to, a capturing system 20, a storage device 250, and at least one processor 260. The electronic device 2 can be, but is not limited to, a mobile phone, a tablet computer, a personal digital assistant (PDA), a personal computer or any other electronic device which provide functions of network connections. FIG. 1 illustrates only one example of the electronic device 2, and other examples can comprise more or fewer components that those shown in the embodiment, or have a different configuration of the various components.

In one embodiment, the storage device 250 can be an internal storage device, such as a flash memory, a random access memory (RAM) for temporary storage of information, and/or a read-only memory (ROM) for permanent storage of information. The storage device 250 can also be an external storage device, such as an external hard disk, a storage card, or a data storage medium. The at least one processor 260 can be a central processing unit (CPU), a microprocessor, or other data processor chip that performs functions of the electronic device 2.

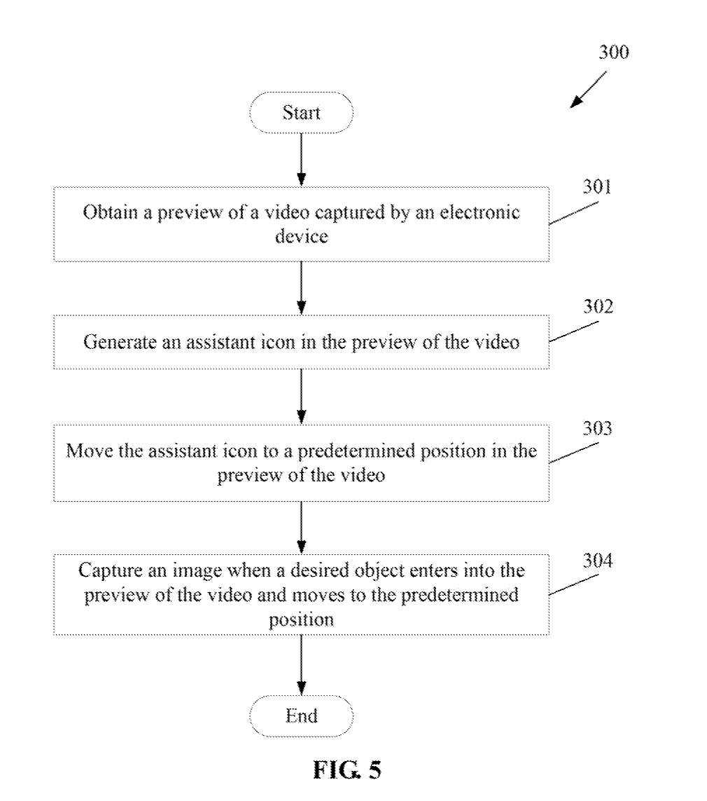

The capturing system 20 comprises, but is not limited to, an obtaining module 210, a generation module 220, a moving module 230, and a capturing module 240. Modules 210-240 may comprise computerized instructions in the form of one or more computer-readable programs that may be stored in a non-transitory computer-readable medium, for example the storage device 250, and executed by the at least one processor 260 of the electronic device 2. A detailed description of the functions of the modules 210-240 is given below in reference to FIG. 5.

FIG. 5 illustrates a flowchart of an example embodiment of a method for capturing an image using an electronic device. In an example embodiment, the method 300 is performed by execution of computer-readable software program codes or instructions by at least one processor of the electronic device.

Referring to FIG. 5, a flowchart is presented in accordance with an example embodiment. The method 300 is provided by way of example, as there are a variety of ways to carry out the method. The method 300 described below can be carried out using the configurations illustrated in FIG. 1, for example, and various elements of these figures are referenced in explaining method 300. Each block shown in FIG. 5 represents one or more processes, methods, or subroutines, carried out in the method 300. Furthermore, the illustrated order of blocks is illustrative only and the order of the blocks can be changed. Additional blocks can be added or fewer blocks can be utilized without departing from this disclosure. The example method 300 can begin at block 301.

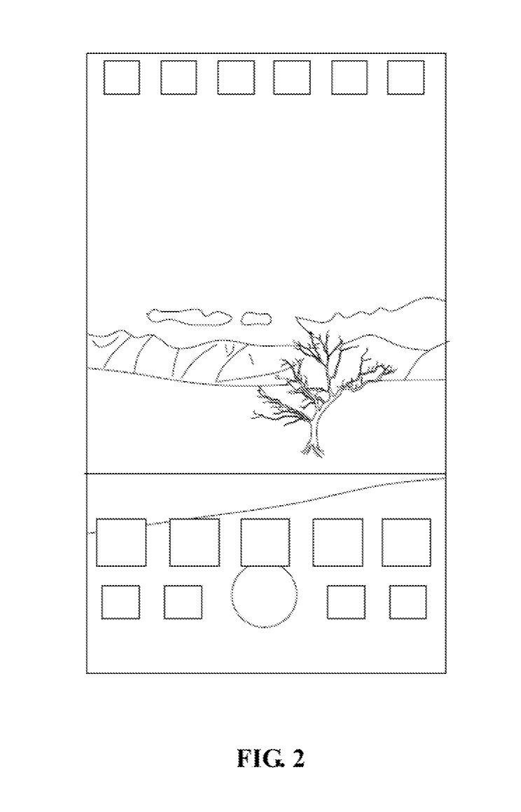

At block 301, an obtaining module obtains a preview of a video captured by an electronic device. As shown in FIG. 2, the video which is captured shows a tree and a mountain, the scene is previewed by a camera of the electronic device to generate the preview of the video. The preview of the video is displayed on a displaying device of the electronic device, so that a user is capable of viewing the scene in the displaying device of the electronic device. In addition, the preview of the video includes one or more virtual buttons, each virtual button has a specific function for operation of videos or images. For example, the preview of the video can be zoomed in or zoomed out using the virtual button. The preview of the video can be adjusted using the virtual buttons.

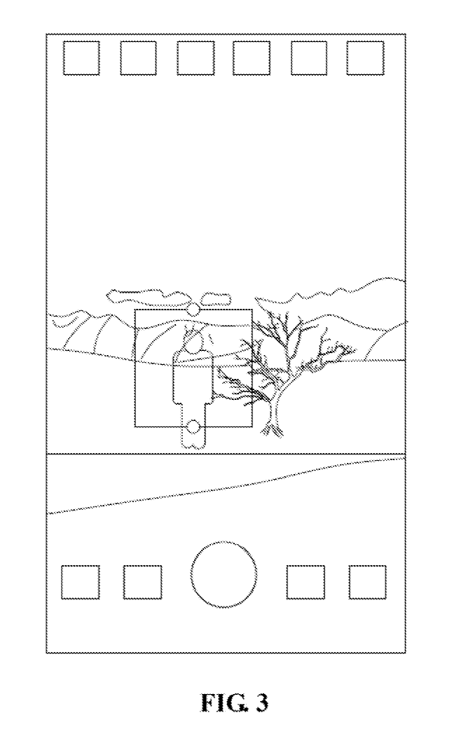

At block 302, a generation module generates an assistant icon in the preview of the video. The assistant icon can be, but is not limited to, a human shape as shown in FIG. 3, a circular shape, a rectangle, a line, a point or any other shapes shown in the preview of the video. The assistant icon is generated at a default position, for example, a centre position of the preview of the video.

At block 303, a moving module moves the assistant icon to a predetermined position. In at least one embodiment, the assistant icon is dragged to the predetermined position by a stylus or a finger of the user to the predetermined position. For example, the assistant icon is pressed by a stylus or a finger of the user more than a predetermined time, for example, three seconds, and the assistant icon can be moved to the predetermined position. In at least another embodiment, for better user experience, the assistant icon can be moved to the predetermined position upon a condition that the predetermined position is indicated by the pressing of the stylus or the finger of the user. In addition, the assistant icon can be adjusted in certain ways, for example, the assistant icon can be zoomed in/out, or be rotated.

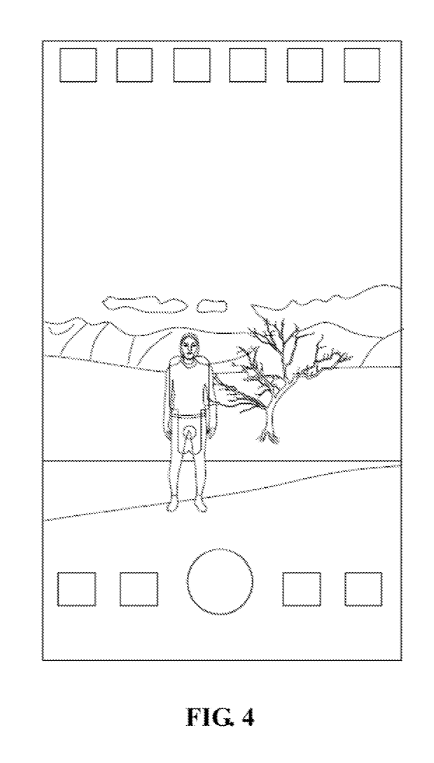

At block 304, a capturing module captures an image of the scene when a desired object enters into the preview of the video and moves to the predetermined position. In at least one embodiment, if the desired object is for example a person, and the person enters into the preview of the video, the user of the electronic device can require the person to move to the predetermined position, and the image including the person, the tree, and the mountain can be captured, as shown in FIG. 4. In at least another embodiment, the capturing module detects a position of the desired object in the preview of the video. The image is captured upon the condition that the actual position of the desired object matches the predetermined position in the display. The virtual buttons and the assistant icon which are displayed are not included in any image captured.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. An electronic device, comprising:
at least one processor; and
a storage device configured to store one or more programs, which when executed by the at least one processor, cause the at least one processor to:
obtain a preview of a video captured by the electronic device;
generate an assistant icon in the preview of the video;
move the assistant icon to a predetermined position; and
capture an image of a scene when a desired object enters into the preview of the video and moves to the predetermined position.

2. The electronic device of claim 1, wherein the preview of the video comprises one or more virtual buttons for adjusting the preview of the video.

3. The electronic device of claim 1, wherein the assistant icon is selected from a group consisting of a human shape, a circular shape, a rectangle, a line and a point.

4. The electronic device of claim 1, wherein the assistant icon is moved to the predetermined position upon a condition that the predetermined position is clicked by the stylus or the finger of a user.

5. The electronic device of claim 1, wherein the at least one processor further detects a position of the desired object in the preview of the video.

6. The electronic device of claim 5, wherein the image is captured upon the condition that the position of the desired object matches the predetermined position.

7. A computer-based method for capturing an image using an electronic device, the method comprising:
obtaining a preview of a video captured by the electronic device;
generating an assistant icon in the preview of the video;
moving the assistant icon to a predetermined position; and
capturing an image of a scene when a desired object enters into the preview of the video and moves to the predetermined position.

8. The method of claim 7, wherein the preview of the video comprises one or more virtual buttons for adjusting the preview of the video.

9. The method of claim 7, wherein the assistant icon is selected from a group consisting of a human shape, a circular shape, a rectangle, a line and a point.

10. The method claim 7, wherein the assistant icon is moved to the predetermined position upon a condition that the predetermined position is clicked by the stylus or the finger of a user.

11. The method of claim 7, further comprising:
detecting a position of the desired object in the preview of the video.

12. The method of claim 11, wherein the image is captured upon the condition that the position of the desired object matches the predetermined position.

13. A non-transitory computer-readable medium having stored thereon instructions that, when executed by at least one processor of an electronic device, causing the electronic device to perform a method, the method comprising:
obtaining a preview of a video captured by the electronic device;
generating an assistant icon in the preview of the video;
moving the assistant icon to a predetermined position; and
capturing an image of a scene when a desired object enters into the preview of the video and moves to the predetermined position.

14. The non-transitory computer-readable medium of claim 13, wherein the preview of the video comprises one or more virtual buttons for adjusting the preview of the video.

15. The non-transitory computer-readable medium of claim 13, wherein the assistant icon is selected from a group consisting of a human shape, a circular shape, a rectangle, a line and a point.

16. The non-transitory computer-readable medium of claim 13, wherein the assistant icon is moved to the predetermined position upon a condition that the predetermined position is clicked by the stylus or the finger of a user.

17. The non-transitory computer-readable medium of claim 13, wherein the method further comprises:
detecting a position of the desired object in the preview of the video.

18. The non-transitory computer-readable medium of claim 17, wherein the image is captured upon the condition that the position of the desired object matches the predetermined position.
